(19) United States
(12) Patent Application Publication
(10) Pub. No.: US 2006/0039730 A1
(43) Pub. Date: Feb. 23, 2006

(54) Paper-size index device used with an image-forming apparatus

(76) Inventor: Jung-yun Won, Suwon-si (KR)

Correspondence Address: STANZIONE & KIM, LLP, 919 18TH STREET, N.W., SUITE 440, WASHINGTON, DC, 20006, US

(21) Appl. No.: 11/183,923

(22) Filed: Jul. 19, 2005

(30) Foreign Application Priority Data
Aug. 18, 2004 (KR) 2004-65112

(51) Int. Cl. G03G 15/00

(52) U.S. Cl. 399/389

(57) ABSTRACT

A paper-size index device and a paper-supplying cassette used with an image-forming apparatus. A paper regulator is installed to be movably set depending on sizes of sheets of paper loaded in the paper-supplying cassette, and a rotational wheel is set at a determined position while rotating by an interaction unit connected to the paper regulator, so that the paper-size information marks provided on one side thereof are exposed through a transparent window. Accordingly, paper-size display and detection operations set at the paper-supplying cassette can be interactively performed.

### CROSS-REFERENCE TO RELATED APPLICATIONS

This application claims benefit under 35 U.S.C. § 119 from Korean Patent Application No. 2004-65112 filed on Aug. 18, 2004, the entire contents of which are incorporated herein by reference.

### BACKGROUND OF THE INVENTION

1. Field of the Invention

The present general inventive concept relates to a paper-supplying cassette used with an image-forming apparatus such as a printer and a photocopier, and more particularly, to a paper-size index device used with an image-forming apparatus to externally show information about a size of a sheet of paper loaded in a paper-supplying cassette.

2. Description of the Related Art

In general, a paper-supplying cassette is detachably mounted in a conventional image-forming apparatus, such as a photocopier or a printer, to supply sheets of paper to an image-forming engine for printing. The conventional image-forming apparatus includes a paper-size detection unit for detecting information about a paper size of the sheets loaded in the paper-supplying cassette, and a paper-size index unit for externally displaying marks so that a user can recognize the paper size.

In general, the paper-size detection unit is installed in the paper-supplying cassette of the conventional image-forming apparatus and has a rack member, a sensor member, and a sensor-activating member that are interactively installed to depend on a setting position of a paper regulator provided in the paper-supplying cassette. The sensor member rotates by the rack member for its position determination, and the sensor-activating member detects a paper size by reading information on the sensor member.

Further, the paper-size index unit is provided within the paper-supplying cassette for the conventional image-forming apparatus independently from the paper-size detection unit. A corresponding paper size is displayed by the paper-size index unit which is manually operated by the user. Here, the paper-size index unit operates independently from operations of the paper-size detection unit and the image-forming apparatus as stated above.

Therefore, if a position of the paper regulator changes its position depending on the paper size of the sheets of paper loaded in the paper-supplying cassette, the conventional image-forming apparatus can automatically detect the corresponding paper size of the sheets by the paper-size detection unit to reflect the information on an image-forming process. However, if a user fails to directly select and set a corresponding mark for the paper size through the paper-size index unit, there is a difference between information about an actual paper size that the image-forming apparatus recognizes and information about a paper size that is externally displayed. This results in discrepancies and other problems with operations of the image-forming apparatus and user's recognition. That is, since the paper size of the paper-size index unit is set independently and differently from the paper size of the paper-size detection unit, the image-forming process cannot be properly performed.

Moreover, the conventional image-forming apparatus causes hassles for usage and deteriorating convenience since a user manually determines the paper size and operates the paper-size index unit through manual manipulations.

### SUMMARY OF THE INVENTION

In order to solve the foregoing and/or other problems, the present general inventive concept provides a paper-size index device and a paper-supplying cassette having the same used with an image-forming apparatus to interactively perform paper-size display and detection operations through position determination of a paper regulator which regulates arrangement of a sheet of paper depending on a paper size of the sheet loaded in the paper-supplying cassette.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a paper-size index device used with an image-forming apparatus, the paper size index device comprising a paper-supplying cassette detachably mounted in a main body of the image-forming apparatus, a paper regulator movably installed to regulate and arrange outer sides of sheets of paper loaded in the paper-supplying cassette, a rotational wheel rotatably installed in the paper-supplying cassette and having paper-size information marks on a front thereof, a paper-size sensing unit disposed at a rear thereof to send paper-size information to the main body, and an interaction unit to rotate the rotational wheel according to a movement of the paper regulator.

The paper-size index device may further comprise a transparent window provided on the paper-supplying cassette to expose one of the paper-size information marks marked on the rotational wheel.

The interaction unit may include a link member installed to be connected to the paper regulator to move along a bottom of the paper-supplying cassette, a rack member installed to be connected to the link member to move along one side of the paper-supplying cassette, and a pinion gear installed on a side of the paper-supplying cassette and rotatably meshed with the rack member and the rotational wheel.

The interaction unit may include the link member connected to the paper regulator to move along the bottom of the paper-supplying cassette, a loop belt mounted to connect a part thereof to the link member, and belt pulleys each installed on a side of the paper-supplying cassette and the rotational wheel so as to rotatably support the loop belt.

The foregoing and/or other aspects and advantages of the present general inventive concept may be achieved by providing a paper-supplying cassette used with an image-forming apparatus, comprising a paper receptacle case detachably installed in a main body of the image-forming apparatus, a paper regulator movably installed to regulate and arrange outer sides of sheets of paper loaded in the paper receptacle case, and a paper-size display unit to externally display paper-size information in interaction with the paper regulator when the paper-size information is provided to a paper-detecting unit installed on the main body.

The paper-size display unit may include a rotational wheel rotatably installed on a side of the paper receptacle case and having corresponding paper-size information marks on both sides thereof, an interaction unit to rotate the rotational wheel as the paper regulator moves, and a transparent window provided on the paper-supplying cassette to expose one of the paper-size information marks marked on the rotational wheel.

The interaction unit may include a link member installed to be connected to the paper regulator to move along a bottom of the paper receptacle case, a rack member installed to be connected to the link member to move along a side of the paper receptacle case, and a pinion gear installed on the side of the paper receptacle case to be rotatably meshed with the rack member and the rotational wheel.

The interaction unit may include the link member installed to be connected to the paper regulator to move along the bottom of the paper receptacle case, a loop belt mounted to connect a part thereof to the link member, and belt pulleys each installed on the side of the paper receptacle case and the rotational wheel so as to rotatably support the loop belt.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view schematically showing a paper-size index device used with an image-forming apparatus according to an embodiment of the present general inventive concept;

FIG. 2 is a side view of the paper-size index device of FIG. 1; and

FIG. 3 is a perspective view schematically showing a paper-size index device used with an image-forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

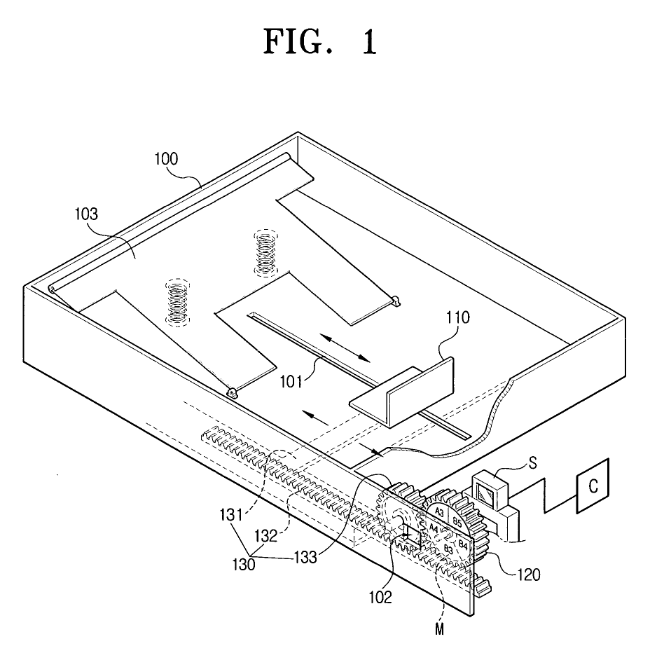

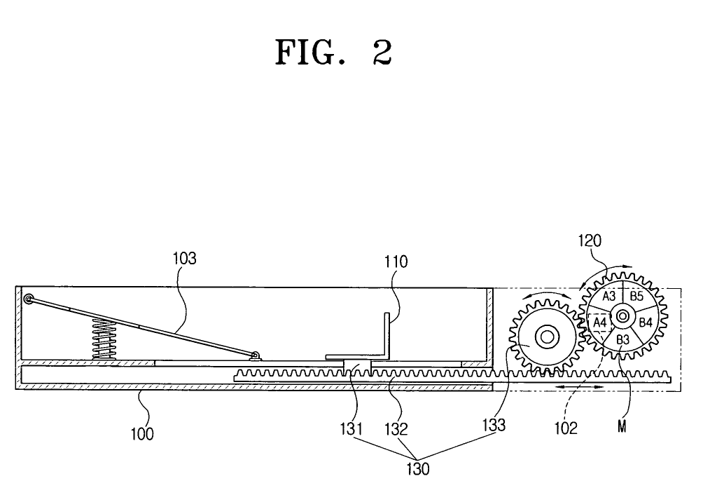

Referring to FIGS. 1 and 2, a paper-size index device used with an image-forming apparatus includes a paper regulator 110 provided in a paper-supplying cassette 100 detachably mounted in a main body of the image-forming apparatus, a rotational wheel 120 having plural paper-size information marks M, a transparent window 102 formed to externally show one selected paper-size information mark M of the rotational wheel 120, and an interaction unit 130 to interact with the paper regulator 110 and the rotational wheel 120. Here, a reference number 103 indicates a hopper plate to elastically bias one or more loaded sheets of paper upward.

The paper regulator 110 is slidingly installed along a guide groove 101 provided on a bottom of the paper-supplying cassette 100 to linearly reciprocate along a longitudinal or widthwise direction of the one or more sheets loaded in the paper-supplying cassette 100.

Further, the paper regulator 110 slidingly moves according to a paper size of the sheets loaded in the paper-supplying cassette 100 to regulate boundaries of the sheets. Thus, the paper regulator 110 can align the sheets so that the sheets can move one by one to an image-forming engine of the image-forming apparatus in order.

The rotational wheel 120 is rotatably installed on a protrusion extended from a one side of the paper-supplying cassette 100. Further, the rotational wheel 120 has gear teeth formed on its outer periphery so as to serve as a gear meshed with a pinion gear 133 to be later described.

The one side of the rotational wheel 120 has information about paper sizes, for example, the paper size information marks M, such as A4, A3, B4, and so on, that are distinguishably marked on sections equally divided on the side of the rotational wheel 120.

The other side of the rotational wheel 120 serves as another distinguishable display unit corresponding to the paper-size information marks M, for example, the other side of the rotational wheel 120 can be provided with diverse paper-size sensing units such as a non-contact-type pattern display unit (not shown) formed with different combinations of a light-emitting element and light-cutoff elements depending on paper-size mark sections or a contact-type sensing unit (not shown) formed with combinations of protruding pins.

The non-contact-type pattern display unit or the contact-type sensing unit provides information to a paper-size sensor S installed on the main body of the image-forming apparatus. Thus, the paper-size sensor S reads the information and sends an information signal to a controller C of the image-forming apparatus, so that a paper size can be detected.

The transparent window 102 selectively and externally shows one or any combination of the paper-size information marks M marked on the rotational wheel 120. Therefore, the transparent window 102 is formed as an opening on the one side of the paper-supplying cassette 100 in which the rotational wheel 120 is installed, so that a user can read and recognize the paper information mark M.

The interaction unit 130 interactively operates according to a movement of the paper regulator 110 to rotate the rotational wheel 120. The interaction unit 130 has a link member 131 installed to be connected to the paper regulator 110, a rack member 132 installed to be connected to the link member 131, and a pinion gear 133 installed to be meshed with the rack member 132 and the rotational wheel 120 so as to simultaneously rotate together with the rotational wheel 120 according to the movement of the rack member 132.

The link member 131 is connected to the paper regulator 110 at one end to linearly reciprocate along the bottom of the paper-supplying cassette 100 and is connected to the rack member 132 at the other end.

Moreover, the rack member 132 is mounted to linearly reciprocate along the one side of the paper-supplying cassette 100 as the paper regulator 110 and the link member 131 linearly reciprocate.

Furthermore, the pinion gear 133 is located between the rack member 132 and the rotational wheel 120, and installed on the one side of the paper-supplying cassette 100, so as to be meshed and simultaneously rotate together with the rack member 132 and the rotational wheel 120.

Hereinafter, description will be made in detail on operations of the paper-size index device of the image-forming apparatus having the above structure according to the present general inventive concept.

First, a user slides the paper regulator 110 to the outer sides of sheets of paper according to the paper size of the sheets of paper loaded in the paper-supplying cassette 100, so that the sheets becomes evenly arranged at a setting position for forwarding the loaded sheets.

Meanwhile, the link member 131 moves as the paper regulator 110 moves. At the same time, the rack member 132 connected to the link member 131 moves along a side of the paper-supplying cassette 100 and is set at a determined position according to a movement of the link member 131. The pinion gear 133 rotates by a movement of the rack member 132. As the pinion gear 133 rotates, the rotational wheel 120 meshed with the pinion gear 133 rotates by a distance corresponding to the rotation of the pinion gear 133, and is set at the determined position. Here, at least one of the paper-size information marks M marked on the rotational wheel 120 corresponding to a paper size set to the paper-supplying cassette 100 is exposed through the transparent window 102, so that a user can recognize the paper-size information mark M from an outside of the paper-supplying cassette 100 of the image-forming apparatus.

Further, when the position of the rotational wheel 120 is determined, paper-size information of the paper-size information mark M provided on the other side of the rotational wheel 120 is read and detected by the paper-size sensor S provided on the main body of the image-forming apparatus. As described above, the paper size information detected by the paper-size sensor S is sent as an information signal to the main controller C of the image-forming apparatus. Thus, the main controller C of the image-forming apparatus automatically detects the paper size of the sheets of paper loaded in the paper-supplying cassette 100 using the paper-size information of the rotational wheel 120, so as to adjust an image-forming scope depending on the paper size corresponding to a print command.

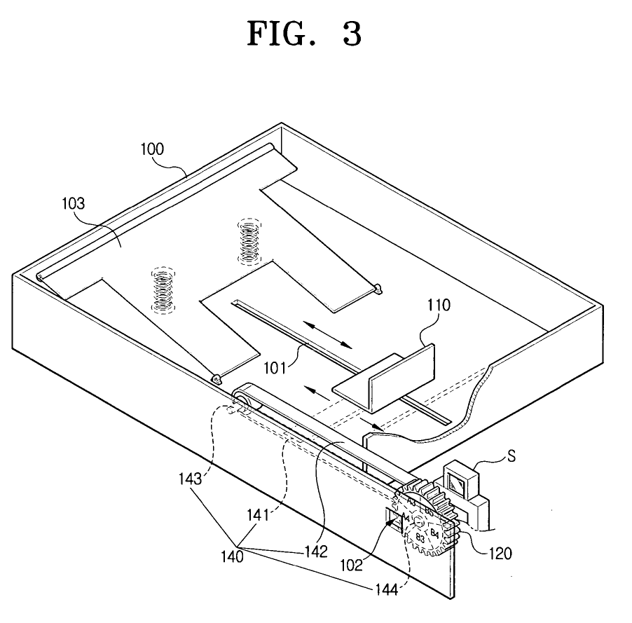

FIG. 3 is a view showing a paper-size index device and a paper-supplying cassette of an image-forming apparatus according to and embodiment of the present general inventive concept. Referring to FIGS. 1 through 3, an interaction unit 140 interactively rotates the rotational wheel 120 as the paper regulator 110 moves. The interaction unit 140 has a link member 141 installed to be connected to the paper regulator 110, a loop belt 142 mounted to connect a part of the link member 141 thereto, and a belt pulleys 143 and 144 each rotatably supporting the loop belt 142 and the rotational wheel 120. Here, like reference numerals of FIG. 1 indicate like elements, so description on the like elements will be omitted.

The link member 141 has one end connected to the paper regulator 110 to move along the bottom of the paper-supplying cassette 100, and the other end connected to a portion of the loop belt 142.

The loop belt 142 is rotatably installed by the belt pulley 143 installed on the one side of the paper-supplying cassette 100 and the belt pulley 144 coaxially installed on an axis of the rotational wheel 120.

Description will be made on operations of the paper-size index device used with an image-forming apparatus having the above structure according to the embodiment of the present general inventive concept.

First, a user slides the paper regulator 110 tightly close to the outer side of the sheets of paper depending on the paper size of the sheets loaded in the paper-supplying cassette 100, so the loaded sheets are evenly arranged at a setting position for forwarding.

Further, as the paper regulator 110 moves, the link member 141 is interactively moves. At the same time, the loop belt 142 to which a part of the link member 141 is connected rotates to be set at a determined position. When the loop belt 142 moves, the belt pulley 144 provided on a shaft of the rotational wheel 120 rotates by an amount of rotation corresponding to the movement of the loop belt 142, and the rotational wheel 120 accordingly rotates to be set at a second determined position. Here, at least one of the paper-size information marks M marked on the rotational wheel 120 corresponding to the sheets loaded in the paper-supplying cassette 100 is set to be exposed through the transparent window 102, so that the user can recognize the paper-size mark from the outside of the paper-supplying cassette 100.

As described above, the paper-size index device used with the image-forming apparatus can automatically and interactively perform the paper-size display and detection operation in real time through the position determination of the paper regulator regulating the arrangement of sheets of paper loaded in the paper-supplying cassette depending on diverse paper sizes, so as to bring an effect of preventing recognition errors since correct information about paper sizes is provided, thereby enhancing usage convenience.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A paper-size index device used with an image-forming apparatus, comprising:
a main body;
a paper-supplying cassette detachably mounted in the main body to receive one or more sheets of paper;
a paper regulator movably installed to regulate and arrange the sheets of paper loaded in the paper-supplying cassette;
a rotational wheel rotatably installed in the paper-supplying cassette, and having paper-size information marks thereon;
a paper-size sensing unit to detect at least one of the paper-size information marks and to send paper-size information to the main body; and
an interaction unit to control the rotational wheel to rotate according to a movement of the paper regulator.

2. The paper-size index device as claimed in claim 1, further comprising:
a transparent window provided on the paper-supplying cassette to expose the at least one of the paper-size information marks marked on the rotational wheel.

3. The paper-size index device as claimed in claim 1, wherein the interaction unit comprises:
a link member connected to the paper regulator to move along a bottom of the paper-supplying cassette;
a rack member connected to the link member to move along one side of the paper-supplying cassette; and
a pinion gear installed on the one side of the paper-supplying cassette, and rotatably meshed with the rack member and the rotational wheel.

4. The paper-size index device as claimed in claim 1, wherein the interaction unit comprises:
a link member installed to be connected to the paper regulator to move along a bottom of the paper-supplying cassette;
a loop belt mounted to connect a part thereof to the link member; and
belt pulleys each installed on the one side of the paper-supplying cassette and the rotational wheel to rotatably support the loop belt.

5. A paper-supplying cassette used with an image-forming apparatus, comprising:
a paper receptacle case detachably installed in a main body of an image-forming apparatus to receive one or more sheets of paper;
a paper regulator movably installed to regulate and arrange the sheets of paper loaded in the paper receptacle case;
a paper-detecting unit installed on the main body to detect paper size information of the sheets of paper; and
a paper-size display unit to externally display paper-size information in interaction with the paper regulator at the same time when the paper-detecting unit detects the paper size information from the paper-size display unit.

6. The paper-supplying cassette as claimed in claim 5, wherein the paper-size display unit comprises:
a rotational wheel rotatably installed on one side of the paper receptacle case, and having paper-size information marks corresponding to the paper size information;
an interaction unit to rotate the rotational wheel according to a movement of the paper regulator; and
a transparent window provided on the paper-supplying cassette to expose at least one of the paper-size information marks marked on the rotational wheel.

7. The paper-supplying cassette as claimed in claim 6, wherein the interaction unit comprises:
a link member installed to be connected to the paper regulator to move along a bottom of the paper receptacle case;
a rack member installed to be connected to the link member to move along a side of the paper-supplying cassette; and
a pinion gear installed on a side of the paper receptacle case to be rotatably meshed with the rack member and the rotational wheel.

8. The paper-supplying cassette as claimed in claim 6, wherein the interaction unit comprises:
a link member installed to be connected to the paper regulator to move along a bottom of the paper receptacle case;
a loop belt mounted to connect a part thereof to the link member; and
belt pulleys each installed on a side of the paper receptacle case and the rotational wheel to rotatably support the loop belt.

9. A paper-supplying cassette used with an image-forming apparatus, comprising:
a paper receptacle case to receive one or more sheets of paper;
a paper regulator to regulate and arrange the sheets of paper loaded in the paper receptacle case according to a size of the sheets of paper;
a paper-size display unit to display paper-size information; and
an interaction unit disposed between the paper regulator and the paper-size display unit to control the paper-size display unit to change a position of the paper-size information according to a movement of the paper regulator.

10. An image-forming apparatus, comprising:
a paper-size index device comprising:
a paper-supplying cassette to receive one or more sheets of paper,
a paper regulator to regulate and arrange the sheets of paper loaded in the paper-supplying cassette according to a size of the sheets of paper,
a rotational wheel having paper-size information marks thereon, and
an interaction unit connected between the paper regulator and the rotational wheel to control the rotational wheel to change a position of the paper-size information marks according to a movement of the paper regulator.

11. The image forming apparatus as claimed in claim 10, further comprising:
a paper-size detecting unit to detect paper-size information corresponding to at least one of the paper-size information marks from the rotational wheel; and
a paper-size display unit to display the paper-size information of the at least one of the paper-size information marks from the rotational wheel.

12. The image forming apparatus as claimed in claim 11, wherein the rotational wheel is disposed between the paper-size detecting unit and the paper-size display unit.

13. The image forming apparatus as claimed in claim 11, wherein the rotational wheel comprises first and second sides both having the paper-size information marks, and the paper-size detecting unit and the paper-size display unit detect and display the paper-size information corresponding to at least one of the paper-size information marks from the first and second sides of the rotational wheel, respectively.

14. The image forming apparatus as claimed in claim 11, wherein the rotational wheel comprises a first side having first marks corresponding to the paper-size information marks and a second side having second marks corresponding to the paper-size information marks, and the paper-size detecting unit detects the paper-size information corresponding to at least one of the paper-size information marks from the first marks of the first side of the rotational wheel while the paper-size display unit displays the paper-size information of the at least one of the paper-size information marks from the second marks of the first side of the rotational wheel.

15. The image forming apparatus as claimed in claim 14, wherein the first marks are disposed on the first side of the rotational wheel in a first arrangement, and the second marks are disposed on the second side of the rotational wheel in a second arrangement.

16. The image forming apparatus as claimed in claim 11, wherein the paper-size detecting unit and the paper-size display unit detect and display the paper-size information according to the position of the paper-size information marks.

17. The image forming apparatus as claimed in claim 11, wherein the paper-size detecting unit detects the paper-size information corresponding to at least one of the paper-size information marks from the first marks of the first side of the rotational wheel.

18. The image forming apparatus as claimed in claim 10, wherein the interaction unit comprises one of a rack member and a belt to connect the paper regulator and the rotational wheel.

19. The image forming apparatus as claimed in claim 10, wherein the interaction unit comprises:
a first member connected to the paper regulator to move in a first direction according to the movement of the paper regulator; and
a second member connected between the first member and the rotational wheel to move in a second direction to rotate the rotational wheel.

20. The image forming apparatus as claimed in claim 10, wherein a center of the rotational wheel is stationary with respect to the paper-supplying cassette, and the position of the paper-size information marks is changed according to the movement of the interaction unit.
